(19) United States
(12) Patent Application Publication
(10) Pub. No.: US 2013/0346327 A1
(43) Pub. Date: Dec. 26, 2013

(54) METHOD AND SYSTEM FOR MONITORING WATER RIGHTS

(71) Applicant: Pinnacle Software, LLC, Salt Lake City, UT (US)

(72) Inventors: Jesse R. Lassley, Cottonwood Heights, UT (US); Collin J. Green, Herriman, UT (US); Michael Bemis, Camarillo, CA (US)

(73) Assignee: Pinnacle Software, LLC

(21) Appl. No.: 13/923,686

(22) Filed: Jun. 21, 2013

Related U.S. Application Data
(60) Provisional application No. 61/663,380, filed on Jun. 22, 2012.
(60) Provisional application No. 61/699,791, filed on Sep. 11, 2012.

(51) Int. Cl. G06Q 30/00

(52) U.S. Cl. CPC G06Q 30/018
USPC 705/317

(57) ABSTRACT

An exemplary method and system for monitoring water rights includes obtaining water rights data from a water rights agency database, maintaining a database of water rights data, receiving a user definition of an alert basis, scanning the water rights database to identify data representative of one or more relevant water rights events, and providing alerts of the relevant water rights events.

### PRIORITY

This application claims priority under 35 U.S.C. §119(e) to U.S. Provisional Patent Application No. 61/663,380 filed Jun. 22, 2012, and U.S. Provisional Patent Application No. 61/699,791 filed Sep. 11, 2012, the contents of which are incorporated herein by reference in their entireties.

### BACKGROUND

Water is one of the most important and vital natural resources. It is the very life-blood of a sustainable society. In the United States, the ownership and use of water is governed by law, usually state law. There are two general legal systems for the regulation of water. In the eastern United States, water is regulated by the riparian rights doctrine. In the western United States, where the climate is often arid and water is more scarce, water is regulated by the prior appropriation doctrine. Under the prior appropriation doctrine, all naturally-occurring waters are deemed to be owned by the public as a whole, but regulated by the states as trustees for the public. The states administer the regulation of water through state regulatory agencies, usually headed by an official often called the “state engineer.” All water not already appropriated, i.e., not being used, is available for appropriation and use by any person for a beneficial purpose. Because water is owned by the public, one who desires to appropriate water to put it to a beneficial use (referred to as an “appropriator”) does not “own” the water, but obtains only a right to use the water. The appropriator therefore only owns a “water right.”

A water rights agency maintains the records and information associated with each water right, usually with a separate file for each water right. The paper records within a water right file are available for review and inspection by members of the public at the office of the water rights agency. In addition, most water rights agencies maintain electronic copies of water rights records, such as in a computer database, which allows the water rights agencies as well as the public to electronically search for and retrieve water rights records and information. Some of these databases and water rights records are available to the public via the Internet.

### BRIEF DESCRIPTION OF THE DRAWINGS

The novel system, methods, and products described herein can be understood in light of FIGS. 1-11, in which:

FIG. 1 depicts an exemplary embodiment of a water rights monitoring system and network.

FIG. 2 depicts an exemplary embodiment of a water rights monitoring system.

FIG. 3 depicts an exemplary embodiment of a high-level flowchart of a water rights monitoring method.

FIG. 4 depicts an exemplary embodiment of a flow chart of an aspect of a water rights monitoring method.

FIG. 5 depicts an exemplary representation of a user interface according to an embodiment of a water rights monitoring method.

FIG. 6 depicts an exemplary embodiment of a flow chart of an aspect of a water rights monitoring method.

FIG. 7 depicts an exemplary embodiment of a flow chart of an aspect of a water rights monitoring method.

FIGS. 8-10 depict representations of a user interface according various exemplary embodiments of the water rights monitoring system and methods.

FIG. 11 depicts an exemplary embodiment of a flow chart of an aspect of a water rights monitoring method.

Together, the Figures illustrate specific aspects of the novel system, methods, and products described herein and constitute a part of the specification. Together with the following description, the Figures demonstrate and explain principles of the system, methods, and products.

### DETAILED DESCRIPTION

The following detailed description includes specific details in order to provide a thorough understanding of the novel method and system for monitoring water rights. Reference is also made to the accompanying drawings which form a part hereof, and in which is shown by way of illustration specific embodiments in which a water rights monitoring tool may be implemented. These embodiments are described in sufficient detail to enable those skilled in the art to implement and/or practice the novel water rights monitoring system and methods, and it is to be understood that other embodiments may be utilized and that structural, logical, and other changes may be made without departing from the spirit and scope of the teachings herein. The following detailed description is, therefore, not to be taken in a limiting sense.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

The various jurisdictions that administer water rights do so through regulatory agencies and entities (“water rights agencies”) according to their own laws, regulations, and procedures, but the methods of administering water rights in all jurisdictions are similar. Water rights agencies include any federal, Indian tribe, state, or local government entity or body that regulates or administers water rights, including but not limited to state executive agencies (often headed by an official titled a “state engineer”), as well as courts and other judicial tribunals. Examples of water rights agencies include, but are not limited to, the Utah Division of Water Rights, California Division of Water Rights (State Water Resources Control Board), State of Washington Department of Ecology, Oregon Water Resources Department, Idaho Department of Water Resources, Arizona Department of Water Resources, New Mexico Office of the State Engineer, Colorado Division of Water Resources, Wyoming State Engineer's Office, Montana Water Rights Bureau, North Dakota State Water Commission, South Dakota Division of Environmental Services (Water Rights Program), Nebraska Department of Natural Resources, Kansas Division of Water Resources (Department of Agriculture), Oklahoma Water Resources Board, Texas Commission on Environmental Quality, Alaska Division of Mining, Land, and (Water Department of Natural Resources), Nevada Water Resources Division, and any of their related agencies. However, a water rights agency may be any government agency or entity that administers water rights.

New water rights may be created by several different methods, each of which is defined more specifically in the relevant jurisdiction's water laws. By way of example, in one method new water rights are created by filing an application with a water rights agency to appropriate water. If approved by the water rights agency, the applicant may then begin the process of putting the water to use, such as by drilling a well or installing a diversion dam in a stream. Once the water has been put to use, the water right applicant/owner may then perfect the water right by obtaining a certificate or license from the water rights agency. Regardless of how a water right is created, a water right, whether perfected or unperfected, gives the water right owner the right to use water only as approved by the water rights agency. The following parameters of a water right may be specified and limited by the water rights agency: (i) the quantity of water approved for use, defined in volume or flow rate; (ii) the approved purposes for which the water can be used (the “nature of use”); (iii) the approved point(s) of diversion (“POD”) where the water can be diverted or withdrawn from the natural hydrologic system, such as from a stream or a groundwater well; (iv) the approved places of use for the water (“POU”); and (v) the periods during the year when the water can be used. In addition, water rights agencies assign a water right a priority date, often based on when the water was first beneficially used or first appropriated. In times of shortage, the water rights with the highest (oldest) priority will be the first to receive water, while those with later priorities will be the first to have the diversion or use of water curtailed.

A standard unit of volume for a water right is the acre-foot, which is the volume of water that covers one acre of land one foot deep. One acre-foot of water is approximately 325,851 gallons. A standard unit of flow rate is second-feet, or cubic feet per second (cfs). Approved natures of use of water often include, but are not limited to, uses such as domestic, agricultural, irrigation, industrial, manufacturing, mining, municipal, stockwatering, storage, power production, and instream flows (e.g. fish habitat).

Water rights are not static. The approved nature of use, PODs, POUs, and period of use for a water right (the “heretofore” parameters) can be changed or transferred to new locations, new periods of use, and/or new purposes of use (the “hereafter” parameters). To make such a change, the water right owner must often file an application with the water rights agency (referred to herein as a “change application”). The water rights agency considers the merits of the change application, and then approves or rejects the change application. Once a change application has been approved by the water rights agency, the water right owner may then begin to make the change, such as by developing a new point of diversion, applying the water to a new place of use, or using the water for a different purpose. Once the change has been completed and the water put to beneficial use in accordance with the change, the water right owner may then perfect the change by obtaining a license or certificate from the water rights agency. For example, if a water right owner desires to move the approved POD from a point on a stream to an underground water well, the water right owner must file a change application with the water rights agency, showing the stream diversion as the heretofore POD and the proposed well location as the hereafter POD. If the water rights agency approves the change application, the water right owner may then begin drilling the well. When the well is complete and has produced water, the water right owner may then perfect the POD change by obtaining a certificate for the change from the water rights agency.

A water right only represents or confers the legal right to use water. Whether there is actual water in the physical source is a different question. In many locations in the United States it is said that there are more “paper” water rights than there is “wet” water in the hydrologic system. Because water is a finite resource, water rights owners must protect their water rights and ability to actually divert and use their water. One of the major threats or potential problems for vested water rights is when third parties also divert water from the same source, or from a nearby source. Such diversions and use of water may reduce the quantity of water available to vested water rights owners with senior priority water rights. Of course, third parties must also apply for and obtain permission from the water rights agencies to begin such diversions. This, as explained above, is usually done by filing a change application, application to appropriate water, exchange application, or other similar type of water right application seeking a new permission to divert water from a source (hereinafter a “water right application”). Once the water right application is filed, notice of the water right application will be given to potentially interested parties, including owners of vested water rights. Protests, objections, or other legal challenges (hereinafter “protests”) may be filed or asserted against the water right application, often pointing out the potential for interference from the new water right application or change. The filing of protests often initiates an adversarial proceeding in which the water rights agency considers evidence and arguments before determining whether to approve or reject, in whole or in part, the water right application. However, the time period to file protests is often limited, and protests not filed within the prescribed time period will not be considered. Also, in some jurisdictions, late protestants lose other legal and procedural rights.

There are also many other deadlines that arise in connection with water rights. Examples of these deadlines include the deadline for filing extension requests to perfect the water right (such as by filing a proof of appropriation or proof of change), and the deadline to file a resumption of use after a water right has been under nonuse.

It is thus important for water rights owners to protect their water rights against interference by monitoring the filing of change applications that, if approved, could potentially interfere with their water rights. It is also important for water rights owners to make sure they meet all deadlines in order to avoid the loss of rights. The novel method and system for monitoring water rights provides a method and system that automatically provides alerts and notices to owners of water rights.

Another type of water right is a water right exchange. A water right exchange involves the release of water into a stream, reservoir or other body of water in exchange for a like quantity of water withdrawn at another point. For example, a person may divert water from a groundwater well in exchange for releasing the same quantity of water, such as from a reservoir, into a river upstream from the groundwater well. Such an exchange is accomplished by first filing an exchange application with the water rights agency. Once the exchange application is approved, the applicant may then begin to make the exchange and put the water to use in accordance with the approval of exchange application.

As used herein, “water rights” refers to all water rights administered by a water rights agency, whether perfected or unperfected, and whether created or arising by a court decree or order, a certificate issued by the water rights agency, a claim filed with a water rights agency or a court, an approved application to appropriate, an approved change application, a water right segregation, and/or an approved exchange application, or any other method under the law of the jurisdiction for creating a water right. It should be appreciated that each jurisdiction may have its own terminology and procedural and substantive nuances with respect to water rights regulation and administration, and that the terms and procedures used and referenced herein are not intended to be limiting but only representative of the nature and type of water right and associated water right data among all jurisdictions.

The system and method for monitoring water rights described herein provide a unique and powerful tool for providing alerts and notices about important activities and deadlines occurring with respect to water rights.

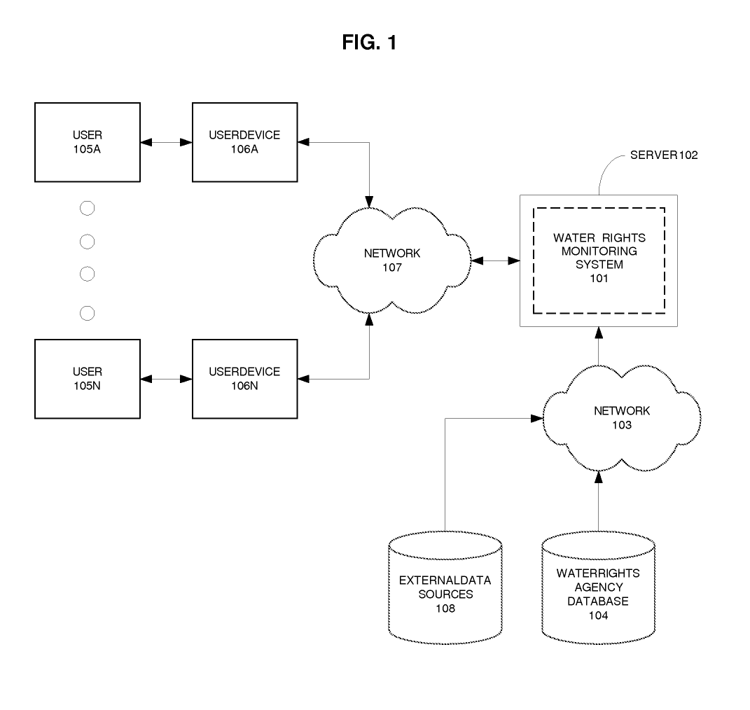

FIG. 1 shows an exemplary embodiment of a water rights monitoring system 101. The water rights monitoring system 101 is located on a server 102 and is connected to a water rights agency database 104 via a network 103. The server 102 receives water rights data from the water rights agency database 104 via the network 103. The server 102 stores the received water rights data in one or more databases (not shown) housed on the server 102. The server 102 receives a search query from a user 105A via a user device 106A transmitted to the server 102 via a network 107. Based on the search query from user 105A, the water rights monitoring system 101 on the server 102 retrieves the relevant water rights data called for by the user's search query and provides an alert to the user device 106A.

The server 102 may comprise one or more servers, computers, processors, or other devices capable of storing or executing the water rights monitoring system 101 and software to perform the methods described herein. The user device 106A is any type of electronic computing device that allows the user 105A to electronically connect with the water rights monitoring system 101 via a network (e.g., network 107) and receive or display visual or graphical results or provide audio outputs and results. The user device 106A includes, but is not limited to, a computer, laptop, tablet, mobile phone, smartphone, personal digital assistant, gaming console, Internet television, and the like. Indeed, the user device 106A may include any type of computer processor configured to communicate via a network with the water rights monitoring system 101 and display results visually, graphically, or audibly, either on the user device 106A or on another visual display or audio device connected to the user device 106A, such as a monitor or touch-screen. Any number of users 105A . . . 105N and user devices 106A . . . 106N may communicate with the server 102.

The networks 103 and 107 may include any type of electronic network, including, but not limited to, the Internet, a local area network, wireless area network, VPN, satellite network, fiber optic network, and the like. The connection to the networks 103 and 107 may be accomplished via a network interface device (not shown), which may comprise, for example, a telephone modem, a cable modem, a DSL line, a satellite, a cellular network, a router, gateway, hub, and the like.

In another embodiment (not shown), the water rights monitoring system 101 is housed on the same server 102 as the water rights agency database 104, without an intervening network 103. In this embodiment, the water rights monitoring system 101 may be maintained and operated as part of the water rights agency database 104. Indeed, the principles of the present invention can be applied directly from a water rights agency database 104.

The water rights agency database 104 contains water rights data regarding the water rights administered by the water rights agency, including, but not limited to, water rights data representative of each water right's reference number, owner(s), POD(s), POU(s), quantity of use, nature of use, period of use, priority date, storage rights, status, and all associated change applications and exchange applications, and any other applications or information associated with the water right (e.g. extensions of time, non-use applications, segregation applications, etc.). The status of a water right is typically classified by the water rights agency as approved, rejected, withdrawn, lapsed, or certificated (i.e. perfected). The water rights data may also include water rights data representative of the basis for the water right, such as a court order or decree, application to appropriate, change application, exchange application, water right segregation, claim, or otherwise. For all change applications, the water rights data may include the “heretofore” and “hereafter” parameters of the water right, including but not limited to the PODs, POUs, quantity of use, nature of use, period of use, priority date, and storage rights. There are also other application types that have similar, relevant data, such as but not limited to, non-use applications, applications to extend the time for filing proof or perfection applications, water reuse applications, and segregation applications. In addition, the water rights data may include hydrologic basins and their boundaries, water rights agency policies, and groundwater management plans. In sum, water right data is any data and/or information stored in the water rights agency database 104 pertaining to water rights.

The water rights monitoring system 101 may also optionally be communicatively coupled to one or more external data sources 108 for providing additional data to the water rights monitoring system 101. For example, in one exemplary embodiment external data sources 108 may include one or more real property databases containing real property data, i.e. data regarding real property parcels. The real property database may be one or more databases containing geo-referenced parcel boundary line data, such as a database of real property parcels maintained or administered by a state tax commission, county assessor, or county recorder. The real property data stored in the real property database may also include data for each parcel such as a parcel number, owner name and contact address, parcel address, and legal description. In this embodiment, the water rights monitoring system 101 receives real property data from the real property database and stores it in the water rights monitoring system 101.

The external data sources 108 may also include any other private, public, and quasi-public data sources and databases having data and information regarding or relating to water rights. For example, external data sources 108 may include any local, state, or federal agencies, legislative bodies, planning and zoning entities, entities governing or relating to the environment, drinking water, and/or water resources, the Environmental Protection Agency, weather centers and services, police and fire departments, military departments, hazardous waste agencies and firms, universities, research entities, businesses and associations such as multiple listing services, real estate brokerages, law firms, engineering firms, geologists, title companies, financial and lending firms, investment firms, water companies, and irrigation companies, individuals, and any other entity that collects or has data regarding or relevant to water rights.

In another embodiment, external sources 108 include sources that may upload, input, or otherwise manually or automatically provide data to the water rights monitoring system 101. By using data from private sources, the system 101 can also provide alerts of data related to water rights but not maintained by water rights agencies, such as water rights sales, transactions, sale prices, and other sale terms (quantity of water sold, to whom, etc.).

In another exemplary embodiment, the system 101 obtains additional data from other sources through use of application program interfaces (“APIs”). The APIs allow the system 101 to obtain any data in any format and use the data in a water rights monitoring method.

In another embodiment (not shown), the water rights monitoring system 101 may be stored on computer media readable by removable disk drive or stored in solid state memory, volatile or otherwise (not shown) in communication with the processor in the user device 106A. For example, the water rights monitoring system 101 may be installed on the user device 106A hard drive, or may be software accessed from a CD-ROM or other removable storage media. In this embodiment, all water rights data and property data is previously obtained from a water rights agency database 104 and external data sources 108 and stored in the water rights monitoring system 101 databases, and may be updated periodically.

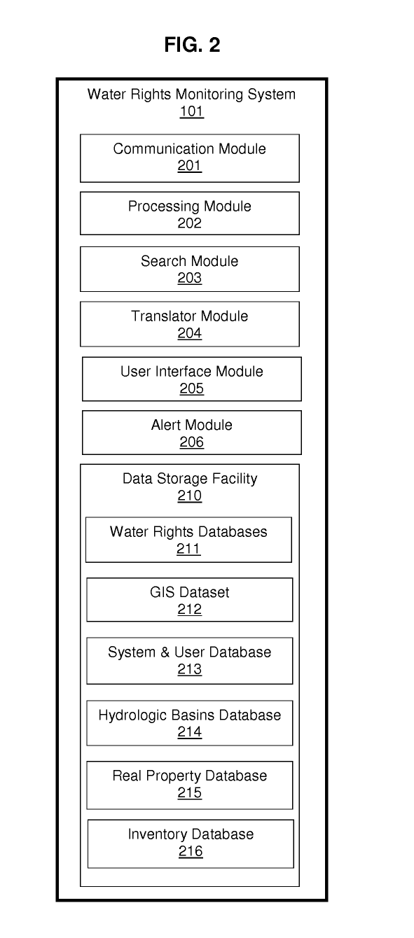

Referring now to FIG. 2, components of the water rights monitoring system 101 are shown in more detail. As shown, the water rights monitoring system 101 may include a communication module 201, processing module 202, search module 203, translator module 204, user interface module 205, alert module 206, and data storage facility 210. The components of system 101 may communicate with one another, including sending data to and receiving data from one another via communication infrastructure, using any suitable communication technologies.

Communication module 201 may be configured to facilitate communication between system 101 and user devices 106N, water rights agency databases 104, and external data sources 108. In particular, communication module 201 may be configured to transmit and/or receive communication signals and/or data to/from user devices 106N, water rights agency databases 104, and external data sources 108. Examples of communication module 201 may include, without limitation, a wired network interface (such as a network interface card), a wireless network interface (such as a wireless network interface card), a modem, and any other suitable interface.

Processing module 202 may include one or more hardware processors and may be configured to execute and/or direct execution of one or more of the water right analysis system processes or operations described herein. Processing module 202 may direct execution of operations in accordance with computer-executable instructions such as may be stored in data storage facility 210 or another computer-readable medium.

Search module 203 may be configured to receive and process a user's search query. The search module 203 is configured to receive a search query from a user device 106A, to run the process described below, to communicate with the system databases, and to return to the user device 106A the results of the user's search query via a user interface.

Data storage facility 210 may include one or more data storage media, devices, and/or configurations and may employ any type, form, and combination of data storage media and/or device. For example, data storage facility 210 may include, but is not limited to, a hard drive, network drive, flash drive, magnetic disc, optical disc, random access memory (“RAM”), dynamic RAM (“DRAM”), other non-volatile and/or volatile data storage units, holographic storage medium, or a combination or sub-combination thereof. Electronic data, including data described herein, may be temporarily and/or permanently stored in data storage facility 210.

In some examples, data may be arranged in one or more databases residing within data storage facility 210. For example, data storage facility 210 may include one or more water rights databases 211 for storing water rights data received from one or more water rights agency databases 104. Data storage facility 210 may also include a geographic information system (GIS) reference dataset 212 that correlates to geo-referenced water rights data and comprises a base layer of the search results output to the user device. Data regarding the users' use of the system 101 may be maintained in a separate system and user database 213 for system data and user accounts. Data storage facility 210 may also include a hydrologic basins database 214 containing hydrologic basins data and a real property database 215 containing real property data obtained from an external data source 108 (e.g., real property database). Inventory database 216 maintains data representative of one or more water rights inventories created by users, and correlates the inventory identifier with the water rights included in the inventory.

The water rights databases 211 generally comprise one or more tables or relational databases for water rights data, but may be any type of database known to those of skill in the art capable of implementation in the present system and methods. In one embodiment, the water rights data is stored in water rights databases 211 in the same form and type of databases as the data is stored in the water rights agency databases 104. In this embodiment, the water rights databases 211 may be a copy of the water rights agency databases 104. The water rights databases 211 may include all of the water rights data included in the water rights agency databases 104. For example, in one embodiment, the water rights databases for Utah comprise separate tables for water rights, owners, change applications, heretofore PODs, heretofore and hereafter nature of use, and correlations among the tables, such as which water rights are evidenced by which changes.

Water rights databases 211 may also include data representative of water rights agency administrative policies. Often, a water rights agency will issue or promulgate policies or groundwater management plans that affect water rights within specific hydrologic basins or other geographic regions. For example, the Utah Division of Water Rights has adopted a policy prohibiting certain POD changes within a portion of the Tooele Valley basin. Data representative of such policies may be maintained in water right rights databases 211.

The GIS datasets 212 include data for graphically representing geo-referenced water rights data, hydrologic basins data, real property data, and any other data stored in data storage facility 210. In one embodiment, the GIS dataset 212 comprises a geo-reference base layer such as a map or ortho-rectified satellite or aerial image. Any type of map may be used as the geo-reference base layer, including a street map, political boundaries map, topographical map, U.S. Geological Survey (USGS) maps, surveys, and the like. The GIS dataset 212 may be based on a geographic coordinate system or a projected coordinate system. The GIS dataset 212 is capable of presenting any geographically referenced data on the geo-reference base layer, and is characterized by either raster datasets or vector datasets. In one embodiment, the GIS dataset 212 is derived from any free, open source, or commercially available GIS web-mapping or imaging application, API or software development kit, such as, but not limited to, Google Maps, GoogleEarth, and OpenLayers. Geo-referenced data stored in the water rights databases 211, hydrologic basins databases 214, real property databases 215, and any other geo-referenced data stored in data storage facility 210 is correlated with the GIS dataset 212 so that it may be displayed on the geo-reference base image layer. The GIS dataset 212 may also include other datasets besides the geo-reference base layer, including but not limited to datasets for features (points, lines, polygons), attributes, and continuous surfaces.

The system and user database 213 stores system and user data about the water rights monitoring system 101 and its users. Such system and user data includes, but is not limited to, a table of registered users, user account settings, user profiles, user billing data, user reports, user search histories, user logins, bandwidth usage, customer service requests, error messages, prior alerts, protests filed, and the like. Indeed, any type of information about the water rights monitoring system 101 and its users may be included in the system database 213.

The hydrologic basins databases 214 may contain all hydrologic basins data. Many water rights agencies geographically divide their jurisdiction according to hydrologic basins and regulate and administer water rights according to the hydrologic basins in which the water rights are located. Hydrologic basins data received from the water rights agency databases 104 generally comprise the geo-referenced location vector data that define hydrologic basins as polygons. Hydrologic basins data may also include any other data associated by the water rights agency databases 104 with the hydrologic basins, such as basin names or identifiers, and correlations to the hydrologic basins data. The hydrologic basins data is geographically referenced to the GIS dataset 212 so that the hydrologic basins may be displayed on the base map layer, such as by showing the basin boundaries or shading or cross-hatching the basin areas.

Real property database 215 stores geo-referenced vector parcel data referenced to the GIS dataset 212. The real property database 215 may be configured to communicate with the search module 203 to allow a user to perform a search query based on geographic location parameters, such as a parcel number or identifier, rather than a water right.

Inventory database 216 stores data relating to water rights inventories. An inventory is a grouping of certain water rights for easier reference and identification by the user. For example, an inventory may include water rights that are owned by the user and/or by one or more other specified owners, thus creating an ownership inventory. In another exemplary embodiment, an inventory may include water rights related by one or more other commonalities as specified by a user or users, such as potential water rights to buy, sell, and/or lease, water rights located within a certain geographic region, and water rights having certain attributes (e.g. flow rate, volume, approved nature of use, etc.). Indeed, there is no limit to how a user may select water rights to be included in the inventory. An inventory may be created and viewed by one or more users. An inventory that may be modified and/or viewed by multiple users is a group inventory. For example, several water rights owners having PODs within close proximity to one another, and/or having common interests, may form a group inventory that may be edited and/or viewed by each member of the group.

An inventory may be created by a user performing a search for water rights, as described below, and selecting the desired water rights to be included in the inventory and then instructing the system to include the selected water rights in an inventory. The system 101 or the user may provide an identifier for the inventory, such as a name or reference number. An inventory may be opened and viewed by a user via a user interface by selecting an option to view details about the inventory. An inventory can be created, edited, and monitored by a user or for the user by an attorney, engineer, or other professional or representative. Once created, data representative of the inventory is stored in inventory database 216.

The water rights analysis system 101 may also maintain a unique set of water rights databases 211, GIS datasets 212, hydrologic basins databases 214, real property databases 215, inventory databases 216, and the like for each different jurisdiction. For example, each state may have a set of databases referred to as the “state databases.”

Translator module 204 translates data obtained from sources external to the system 101, such as water rights agency databases 104 and external data sources 108, for use in the system 101 to run the processes described below. The translator module 204 allows the water rights analysis system 101 to run the same processes with only one set of instructions on all search queries for all jurisdictions. The translator module 204 allows the same front end of the system 101 to receive data from water rights agencies in multiple different jurisdictions and to deal with database schema changes. In one exemplary embodiment, because each jurisdiction and water rights agency uses its own terminology and field identifiers in its water rights agency databases 104, the translator module 204 translates the data into a common format or identifier for easier use with the front end of the water rights monitoring system 101. For example, Utah's CH_STATUS field is translated to CHANGE_STATUS. Another state may have a field named TRANSFER_STATUS, which would also translate to CHANGE_STATUS so the field name is the same from the front end for all state water rights data.

In another embodiment, the translator module 204 translates data obtained from the water rights agency databases by consolidating related data into single rows in the tables. For example, water rights data maintained by a water rights agency may have a separate row for every instance that an owner or a POD is used in a water right application, thus leading to many duplicate rows and errors associated with new or updated data. The water rights monitoring system 101 is structured to have one row for an owner, POD, or water right so as to eliminate the above-described problems. This is done by the translator module 204, which normalizes multiple rows in the water rights agency data into one row whenever the multiple rows are determined to be the same. For example, this may be done by matching the first name, last name, care of, address, address city, and address fields for water right owners and/or water right protesters. For PODs, the normalizing may be done by matching the POD type and geographic location of the PODs.

Additionally, the translator module 204 may also fix imported data by removing unprintable strings and control characters and translating Universal Transverse Mercator (UTM) coordinates into latitude and longitude coordinates.

In one embodiment, the water rights data is translated by the translator module 204 only when a user initiates a search. In an alternative embodiment, data by the system 101 is translated before it is stored in the system's databases. Thus, the system's databases are not exact copies of the water rights agency databases 104, but instead are already in a format useable by the water rights monitoring system 101 when a user search query is received. However, it should be appreciated that either arrangement may be used in the water rights monitoring system 101. Maintaining the system's databases in the same format as the water rights agency databases 104, and thus translating the water rights data only when a user initiates a search query, makes updating the system databases from the water rights agency databases 104 easier and faster at the cost of slightly more processing time when a user performs a search. On the other hand, translating the data received prior to storing it in the system's databases makes updating the system's databases longer and more cumbersome, but decreases the processing time when a user performs a search. It should be understood that the system 101 may receive water rights data, hydrologic basins data, and property data from water rights agency databases, hydrologic basins databases, and real property databases at any time, and at any scheduled interval. For example, the system 101 may update all databases once a week at a time when few users are likely to be using the system 101.

The water rights monitoring system 101 and associated components may be implemented in one or more subsystems. In one exemplary embodiment, the system 101 and its associated components are implemented by a state agency database system, and are only connected by internal networks. In this way, the state agency may provide water right alerts to users. It should further be appreciated that the system and methods described herein may operate directly from the databases external to the server, including the water rights agency database, real property database, and hydrologic basins database. In this way, the system does not have its own internal databases. The spirit and scope of the invention is still served by such a system, which provides water rights alerts when information and data in the water rights databases changes.

User interface module 205 may be configured to provide one or more user interfaces configured to facilitate user interaction with system 101 and enable the user to run the processes described herein and implement the water rights monitoring system and methods. For example, user interface module 205 may provide a user interface through which one or more functions, options, features, and/or tools may be provided to a user and through which user input may be received. The search module 203 may provide such interface. In certain embodiments, user interface module 205 may be configured to direct a user device to display one or more web pages and/or any other content as may serve a particular implementation. In another embodiment, the user interface comprises a mobile app for use on mobile handheld devices such as tablets and smart phones. Indeed, the water rights monitoring system may be configured to be accessed, run, and operated by a user on any type of handheld device.

Alert module 206 is configured to generate and store, in data storage facility 210, alert rules for providing alerts of water rights events, as set forth below in more detail. Alert module 206 receives a user definition of an alert basis and user preferences and directs the system to scan the water rights databases and any other databases to identify relevant water rights events provides alerts of relevant water rights events in accordance with the alert basis and the user preferences, as described herein.

The databases and components of the system are not limited to the singular or plural as used herein, it being understood that were the singular of a component is referenced, it could comprise multiple components, and where multiple are referenced, there could be only one. Thus, reference to a database may include one or more databases, and reference to databases may comprise only one database.

In some examples, one or more of the modules 201-206 and data storage facility 210 shown in FIG. 2 may be implemented at least in part as computing instructions (e.g., as one or more applications) residing within data storage facility 210 or other computer-readable medium and configured to direct processing module 202 to perform and/or direct one or more other components of water rights monitoring system 101 to perform one or more of the processes and/or operations described herein. In certain embodiments, for example, alert module 206 may be implemented, at least in part, as computing instructions residing within data storage facility 210 and configured to direct processing module 202 to perform one or more of the processes and/or functions described herein.

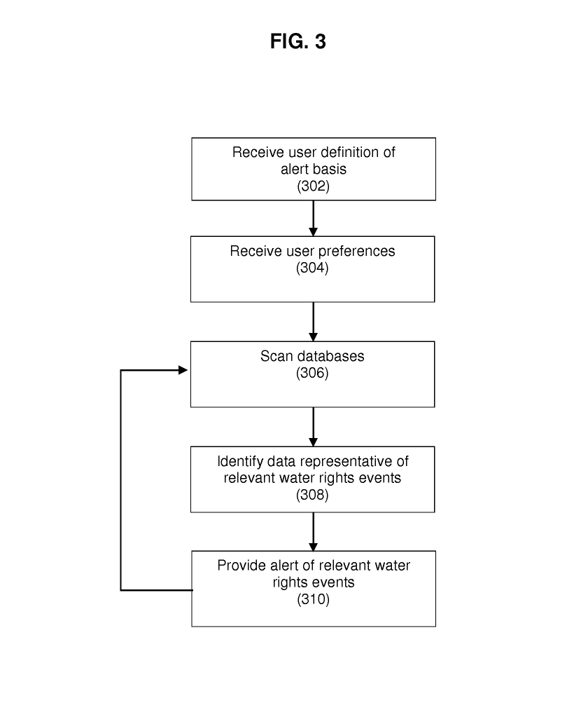

An exemplary method for monitoring water rights and providing alerts of water rights events is illustrated in FIG. 3. FIG. 3 shows a high-level flowchart of one embodiment of a process that implements functions of the water rights monitoring system 101 described above. While FIG. 3 illustrates exemplary steps according to one embodiment, other embodiments may omit, add to, reorder, and/or modify any of the steps shown in FIG. 3. In certain examples, one or more of the steps of the method shown in FIG. 3 may be performed by a water rights monitoring system such as the water rights monitoring system 101 described above.

A user creates an alert rule that defines what alerts are to be provided to the user and the manner of providing the alerts. The water rights monitoring system first receives a user definition of an alert basis (step 302). The alert basis is the water right or group of water rights for which alerts will be provided by the system. In one exemplary embodiment, the alert basis may include one or more designated water rights, one or more designated water right owners, a geographic region, and/or an inventory. The alert basis may be defined by a user performing a search to identify and select one or more water rights, water right owners, geographic regions, or inventories maintained within data storage facility 210. The procedure for performing the search to define the alert basis is described herein in more detail. The system may also receive from the user preferences that define parameters for identifying relevant water rights events and/or providing alerts (step 304).

The system scans the databases included in data storage facility 210 (step 306) and identifies data representative of relevant water rights events, if any (step 308). The system may scan the databases and identify data representative of relevant water rights events as described herein in more detail. If the system identifies data representative of relevant water rights events, the system provides an alert of the relevant water rights events in accordance with the user preferences (step 310). The system may provide an alert of the relevant water rights events in any manner as described herein in more detail.

As used herein, a “water rights event” includes any event that causes changes to water rights data and administrative policies data included in water rights databases 211 and hydrologic basins data included in hydrologic basins databases 214. For example, water rights events include the addition, filing, modification, correction, deletion, removal, or issuance of applications to appropriate, change applications, exchange applications, segregation applications, claims, nonuse extensions, sewage effluent reuse, proof extension requests, proofs, protests, resumption of use after nonuse, manual changes to the water rights agency databases, court or litigation records, correspondence, memoranda, photographs, notes, certificates of beneficial use, certificates of change, notices, proof due letters, orders, decisions, administrative policies, and any other documents or events associated with a water right file or water rights agency.

Water rights events may also include due dates and deadlines associated with a water right, as well as dates that precede or follow the due dates and deadlines by a predetermined amount of time. For example, a proof due deadline of Jun. 30, 2013, would be a water right event. In addition, the system may receive a user preference that sets all dates that are sixty days prior to a proof due deadline as a water rights event. Thus, May 1, 2013 would also be a water right event. Examples of due dates and deadlines include, but are not limited to, protest deadlines, proof due deadlines, extension request deadlines, and resumption of use deadlines.

In another embodiment, water rights events may include a change in a water right's priority ranking. For example, a water right may be ranked by the system 101 by a raw priority ranking (number of water rights having an earlier priority date), a quantity priority ranking (a total volume of all water rights have an earlier priority date), a flow priority ranking (a total flow of all water rights having an earlier priority date), and an ownership priority ranking (the number and/or names of distinct owners that own water rights having an earlier priority date). These ranking results can be within distinct hydrologic basins, sub-basins, custom areas, or upstream by source, or any other geographic regions as may suit a particular implementation. Monitoring for changes in a water right's priority ranking over time provides a valuable tool for monitoring and protecting a water right.

Water rights events may also include changes in data originating from external sources 108, such as sales of water rights, offers for sale, sales prices, sales terms, leases, transfers of water rights, filing and/or disposition of liens against water rights, reported spills and releases of hazardous waste, hazardous materials, and hazardous substances, environmental monitoring, environmental enforcement actions, violation notices, lawsuits, zoning changes, ownership and title changes in real property parcels where PODs are located, as well as adjacent and/or nearby parcels, and the like.

As used herein, a “relevant water rights event” is a water right event that is associated with the alert basis and that satisfies any user preferences for the alert rule. Where the alert basis is one or more water rights and/or owners, relevant water rights events are those water rights events associated with the one or more water rights and one or more owners designated as the alert basis. For example, if a user defines the basis of the alert as all water rights owned by the user, the system will scan the water rights data in water rights databases 211 associated with the user to detect any data representative of water rights events. Any such water rights events that also satisfy any user preferences set for the alert rule will be relevant water rights events.

Where the user designates a previously-created inventory as the alert basis, relevant water rights events may include all water rights events associated with the water rights included in the inventory. Where the user designates a geographic alert area as the alert basis, the relevant water rights events may include the water rights events associated with a water right having geo-spatially referenced water rights data elements located in the geographic alert area.

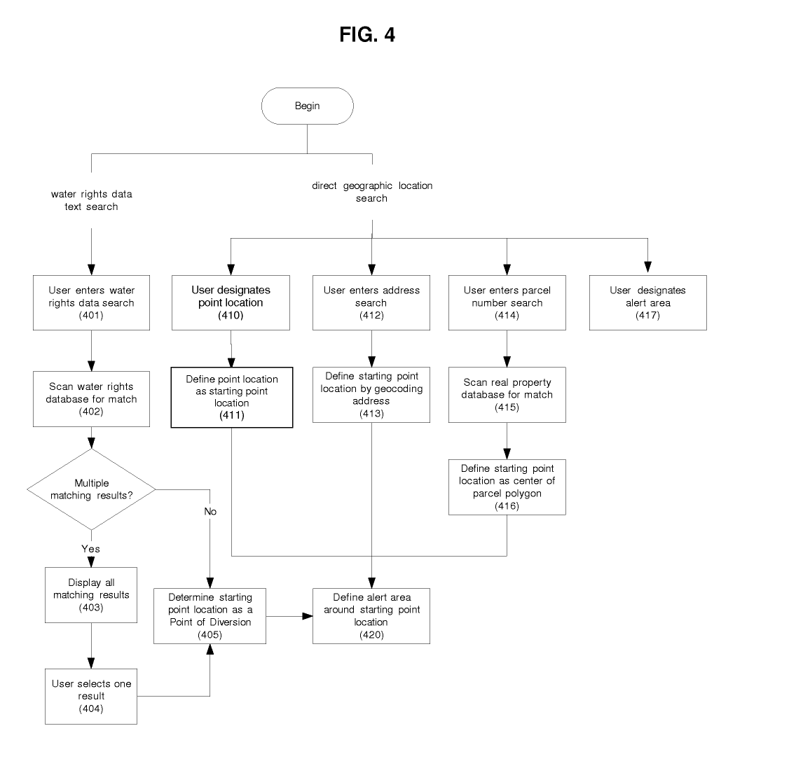

An exemplary process for defining the alert basis is illustrated in FIG. 4. FIG. 4 shows one embodiment of a process that implements functions of the water rights monitoring system described above. While FIG. 4 illustrates exemplary steps according to one embodiment, other embodiments may omit, add to, reorder, and/or modify any of the steps shown in FIG. 4. In certain examples, one or more of the steps shown in FIG. 4 may be performed by a water rights monitoring system such as the water rights monitoring system 101 described above.

A user may define the alert basis as a geographic region. For example, the system may receive a search query from a user in order to define a geographic alert area. The search query is used to determine a geographic starting point location on the geo-reference base layer around which an alert area can be defined. The search query may comprise a water rights data text search created by the user entering a search term into a search field on the user interface (step 401). The search term may be any of the water rights data in the system water rights databases, such as but not limited to a water right number, water right owner, change application number, address, city, or county. It should be appreciated that the system may be configured to allow the user to search for any of the water rights data in any of the system's databases. The system scans the water rights databases 211 for matching data to identify a matching water right (step 402). If there are several matching results, such as if several water rights are owned by the same owner, the system displays a listing of all matching water rights (step 403) and allows the user to select the desired water right or water rights (step 404). If there is only one matching result, or if the user has selected one water right from a list of multiple results, the system may define a geographic starting point location as any one of the PODs of the water right, as described below in more detail (step 405).

Additionally or alternatively, the search query may comprise a direct geographic location search instead of a water rights data search. For example, the system may display the geo-reference layer, such as a map or aerial photo, at the outset on the user device. In one embodiment, the user may designate a geographic point location on the geo-reference layer (step 410). This may be done by drag-and-drop, i.e. allowing the user to select a point location marker by clicking on the marker (with the use of a mouse or touch-pad or other user-controlled device) and dragging it onto the geo-reference layer and dropping the marker at the desired location where the user wishes to query the system for water rights data. Alternatively, the geographic search may be performed by allowing the user to point a cursor or arrow or other similar marker controlled by the user at the location on the geo-reference layer and then performing a user-controlled action to designate the location, such as clicking, double-clicking, or right selecting and selecting an option from a pop-up menu. In another exemplary embodiment, the direct geographic search may be performed by obtaining the user's geographic location from identification information provided by the user or a GPS or other location based data from the user device, including a mobile phone, tablet, or smart phone. In this embodiment, the system may define the geographic starting point location as the user's current geographic location as obtained from the user's device. The system may define the geographic starting point location as the geographic point location (step 411).

In a further embodiment, the direct geographic search query may include a user searching for a physical location address, county selection, or zip code (a “location search”) (step 412). In this embodiment, the system determines a geographic starting point location for the address or zip code by geocoding (step 413). Geocoding is the process of determining associated geographic point location coordinates from other information, such as street addresses or zip codes. Any type of geocoding system may be used, including those available through third parties.

In another embodiment, the direct geographic search query may comprise a parcel number search, commenced by the user entering a property parcel number (step 414). The number is of the type assigned or maintained by a state, county, or other government entity, such as a tax parcel number, for real property parcels. The system scans the real property database to locate a matching parcel (step 415). A geographic starting point location is then derived from the property data by retrieving the polygon vector data defining the parcel's boundaries and determining the geometric center of the parcel polygon (step 416). Additionally or alternatively, the system may define a geographic starting point location from a parcel number search by scanning the real property database to determine the physical address for the parcel number, and then determining a geographic point location coordinate for the address as described above through the use of geocoding.

The system may define one or more geographic alert areas around the geographic starting point location(s) (step 420). An alert area generally comprises a set of vector data creating a polygon layer on the geo-reference layer. The shape of the alert area may be any shape, such as a circle, rectangle, or polygon, and may be defined by the user. For example, the alert area may be a circle around a well POD serving as the geographic staring point location. In another exemplary embodiment, the alert area may be the hydrologic basin polygon in which the geographic point location is located, as defined by the water rights agency hydrologic basin data or water rights agency reference basin data from other sources.

The user may also designate a geographic search area without defining a geographic starting point location (step 417). In one embodiment, the user may do this by manually defining a polygon, circle, box, or rectangle to define a desired alert area, such as by clicking and holding as the user drags a mouse to define the area. Or, the system may include a set of shapes that the user can drag or draw on the desired location. In another embodiment, the user may designate a county, municipality, hydrologic basin, or township and range, and may further include a section search within the township and range.

The alert basis may also be defined based on common water sources, such as a river, stream, spring, lake, reservoir, or aquifer. For example, the water rights monitoring system may allow a user to receive alerts regarding activity on surface waters. Because changes to a water source upstream will often affect downstream water users, it is desirable to have a method to monitor upstream changes without having to physically be on location, as often times terrain is rugged and difficult to maneuver, or upstream changes may happen at great distances from the downstream area of concern.

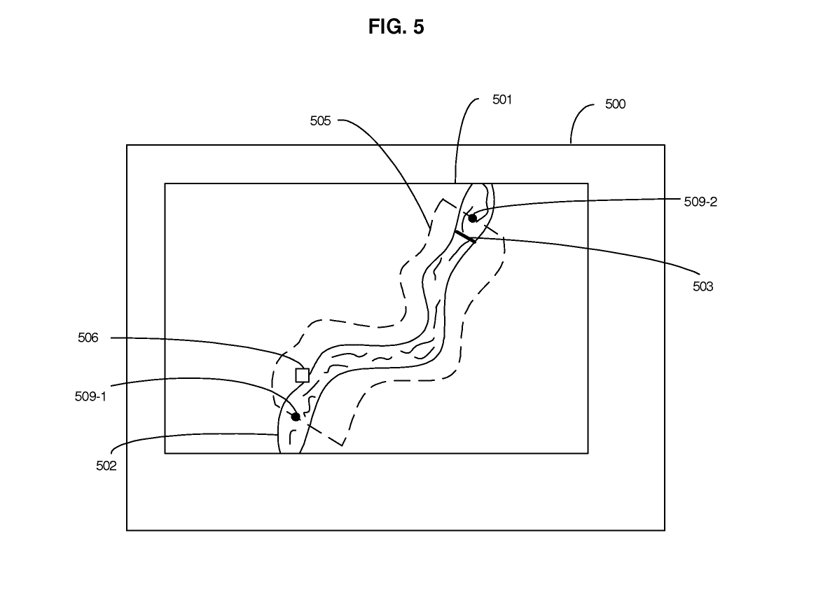

To monitor activities on rivers and streams, the system allows the user to enable “river mode” for designating surface water sources as the geographic alert area. The user may then define an alert area along the surface source by designating a width of the alert area in relation to the center line of the river, or an edge of the river, and a length in relation to two points on the center line or edge of the river. For example, as shown in the exemplary user interface 500 in FIG. 5, a user may define the alert area 505 on geo-reference base layer 501 as the area comprising one hundred feet (100 feet) on either side of river 502 between the user's POD 506 on river 502 and a reservoir dam 503 upstream.

In one embodiment, the user may do this by designating endpoints 509-1 and 509-2 for the alert area manually by designating the endpoints on the geo-reference base layer 501. The water rights monitoring system then identifies all the center points on the river between these selected endpoints. The system generates the alert area 505 polygon by selecting boundary points on both sides of the river at the distance designated by the user from the center of the river, with the boundary points perpendicular to the next point in the sequence.

In this way, the system allows the user to define an alert area polygon that follows a river without the user having to manually create all of the boundaries of the polygon, which would be a time consuming and error-prone process. Instead, the user simply identifies the two endpoints, and the distance from both sides of the river to be monitored. It should be appreciated that this method works for any type of surface source, including lakes, streams, rivers, ponds, drains, and the like.

Alternatively or optionally, the user may also designate the alert area by naming a surface water source, such as a river, stream, lake, reservoir, or spring. All water rights events associated with water rights identifying any of the specified surface water sources will be deemed a relevant water right.

With respect to groundwater sources, a user may designate the alert area as a particular aquifer. The system may then compare well depth information of water rights events or associated water rights, such as a proposed new well, with aquifer depth and location data obtained from water rights agencies 104 and/or external sources 108. In this way, any water rights events located within or affecting the specified aquifer may be relevant water rights events.

The alert area may be any size as may serve a particular implementation. The system may have a default setting for the size of the alert area, or may allow the user to adjust the default setting by displaying the alert area on the geo-reference layer on the user device and allowing the user to refine, resize, and/or reshape the alert area at any time during the process as desired by the user.

For example, if a user owns a groundwater right with one well POD and wants to monitor all water rights activity occurring within a 2 mile radius of the well, the user will search for the water right as described above, then select an option provided by the system to define an alert area surrounding the groundwater right POD.

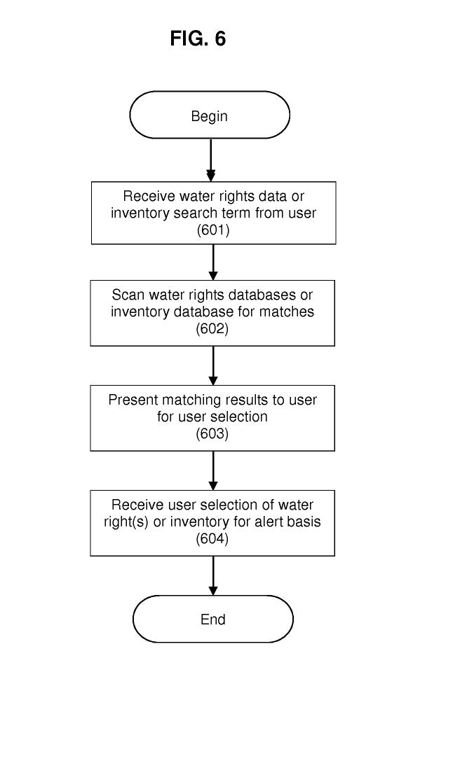

An exemplary process for defining the alert basis based on a water right, a water right owner, and/or an inventory is illustrated in FIG. 6. FIG. 6 shows one embodiment of a process that implements functions of the water rights monitoring system described above. While FIG. 6 illustrates exemplary steps according to one embodiment, other embodiments may omit, add to, reorder, and/or modify any of the steps shown in FIG. 6. In certain examples, one or more of the steps shown in FIG. 6 may be performed by a water rights monitoring system such as the water rights monitoring system 101 described above.

As shown in FIG. 6, a search query may be received by the water rights monitoring system from a user. In one exemplary embodiment, the search query may comprise a water rights data search created by the user entering a search term into a search field on the user interface (step 601). The search term may be any of the water rights data or inventory data in the system water rights databases, such as but not limited to a water right number, water right owner, change application number, address, city, county, or inventory name. It should be appreciated that the system may be configured to allow the user to search for any of the water rights data and inventory data in any of the system's databases. The system scans the water rights databases and/or inventory database for matching data to identify a matching water right or inventory (step 602). If there are several matching results, such as if several water rights are owned by the same owner, the system displays a listing of all matching water rights or inventories, as the case may be (step 603), and allows the user to select the desired water right or water rights or inventory (step 604). If there is only one matching result, or if the user has selected one water right or inventory from a list of multiple results, the selection is the alert basis of the water right alert rule. In another exemplary embodiment, the user may search for water rights, owners, and inventories by browsing that data stored in the system's water rights databases instead of searching by using search terms.

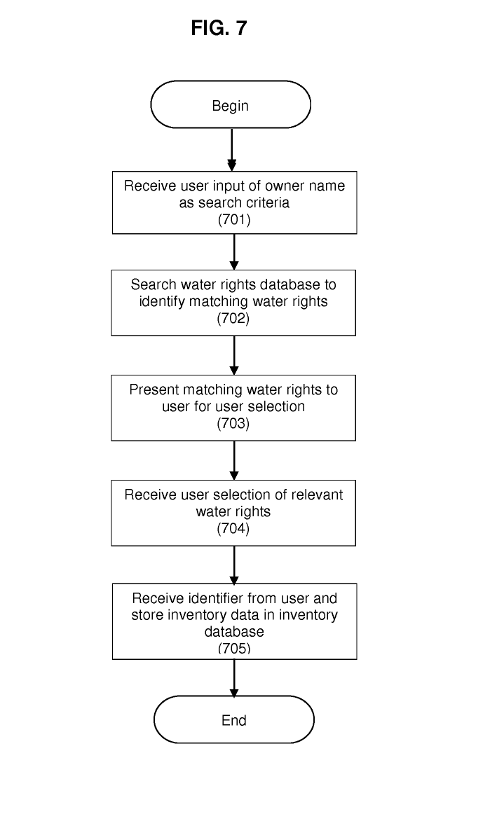

An exemplary process for creating an inventory is illustrated in FIG. 7. FIG. 7 shows one embodiment of the process that implements functions of the water rights monitoring system described above. While FIG. 7 illustrates exemplary steps according to one embodiment, other embodiments may omit, add to, reorder, and/or modify any of the steps shown in FIG. 7. In certain examples, one or more of the steps shown in FIG. 7 may be performed by a water rights monitoring system such as the water rights monitoring system 101 described above.

As shown in FIG. 7, a search query is received by the water rights alerts system (step 701). The search query may comprise all or part of an owner name, such as a last name, a first name, an entity name, and the beginning letters of a first or last name. The search query may also include additional information to further identify the owner, such as owner's address, or a “care of” (c/o) designation. The system then searches the water rights database to identify all water rights associated with the owner specified in the search query (step 702).

In one embodiment, the search accounts for spelling errors in the owner name data maintained in the water rights database, because water rights data obtained from a water rights agency often contains spelling and typographical errors. In this embodiment, every owner name in the water rights database is parsed into separate words (e.g. first name, middle name, last name, entity name) for comparison with the search query terms. The system accounts for spelling errors by comparing each of the following permutations of the search query against the parsed owner names from the water rights databases: all names having an added letter (a-z) at the beginning, an added letter at the end (a-z), a change in any one letter to a different letter (a-z), and/or a change in any second letter to a different letter (a-z). It should be appreciated that methods other than those described herein may be used to capture errors and misspellings in owner name data. Matches are added to a list of possible search results and presented to the user for user selection (step 703). The user then selects the desired water rights, i.e. the water rights that the user desires to include in the inventory (step 704). The user may then create an identifier for the inventory, such as a name, ID number, client number, matter number, or the like, and data associated with the inventory, such as the inventory identifier and the water rights associated with the inventory, is stored in inventory database 216 (step 705).

Users may edit inventories by adding and removing water rights at any time. In another embodiment, when a water right is sold, the system may be configured to alert the new owner to prompt for continued service, and may report sales information.

Additionally or alternatively, an alert basis may be defined as a combination of one or more geographic alert areas and one or more water rights, owners, and inventories. For example, the user may define an alert basis as each of the water rights included in an inventory as well as a geographic alert area around each of the water rights in the inventory, such as a one-mile radius around each POD in the inventory.

As shown in FIG. 3, the system may be configured to allow the user to specify user preferences for identifying relevant water rights events. In one exemplary embodiment, the user preferences may specify one or more categories or types of water rights events for which the user desires to receive alerts, such as applications to appropriate, change applications, exchange applications, protests, and proof extension requests. In another exemplary embodiment, the user may specify that only water rights events associated with water rights having a priority date after a certain date specified by the user, or after a priority date of a specified water right, are relevant water rights events. In another embodiment, the user may specify a minimum quantity or flow rate of a water right associated with a water right event. Other water rights data elements that may be used to refine the alert rule include depletion percentages and amounts and nature of use. Indeed, any of the water rights data elements may be utilized, alone or in combination with other water rights data elements, to further refine and define what constitutes relevant water rights.

The user may also input one or more user preferences specifying when alerts of due dates and deadlines will be provided. The system may track relevant dates and deadlines for water rights included in the alert basis, and may provide alerts at predetermined times prior to those deadlines. The user may set the predetermined times when such alerts are provided. The user may select the deadlines for which he or she desires to receive alerts, and when those alerts will be provided. For example, a user may specify that alerts for proof due deadlines are to be provided sixty days in advance of the proof due date, and alerts for protest deadlines are to be provided one week in advance of the protest deadline.

The system may also be configured to allow the user to specify user preferences for how the system provides alerts of relevant water rights events. For example, the user can set the desired frequency for scanning the system databases for new water rights events. For example, the user may configure the system to scan the databases daily, weekly, bi-weekly, or any other time frame as desired by the user. The user can also specify when alerts will be provided. For example, the user can configure the system to provide alerts in real time, daily, weekly on a specified day, or in any other manner as desired by the user or as may suit a particular implementation.

The user preferences may also include the preferred form or forms of alerts, such as email, fax, text message, SMS, MMS, voice message, or the like. The user may also specify what content is to be included in the alerts, such as a summary of the water right event, a hyperlink to a database file, a copy of the document(s) associated with the water right event, forms or other documents for taking action with respect to the water right event, a map depicting the geographic location of the water right event, charts, data, and the like.

In another embodiment, the user can specify multiple recipients, and can set individual preferences for each different recipient. For example, an attorney may establish an alert rule designating himself as a first recipient with detailed alerts, and the client as a second recipient with summary alerts.

After the alert basis and any user preferences have been defined, the system stores the alert rule so that it can routinely scan the system databases to identify relevant water rights events and provide alerts to the user based on the relevant water rights events. The system may scan the databases periodically or routinely, as may be defined by the user or by default settings.

The water rights monitoring system may detect water rights events in different ways. In one exemplary embodiment, water rights events are detected by comparing the existing water rights data in data storage facility 210 against the data obtained from water rights agency database 104 each time a new update is downloaded by the system from the water rights agency database 104.

In an alternative or additional embodiment, the system checks for changes in electronic or paper documents scanned and stored in the water rights agency database. Each such document is downloaded by the system 101 and hashed using any common low collision hashing algorithm to generate a fixed length string, such as a 64-character or 128-character hash. The hash is stored in the water rights databases 211 in the system along with the time the document was downloaded and hashed. The next time the file is checked from the water rights agency database 104, a new hash is generated and compared with the stored hash. If the new hash is different the file has changed, in which case the system 101 saves the downloaded document in the water rights databases and may provide a notification to an administrator or to a user via an alert on the website. All previous versions of the document can be stored over time to show a full history of changes. This can be done by storing every version of the document explicitly or by storing the incremental changes or any other algorithm known to those skilled in the art.

To this end, the water rights monitoring system may obtain water rights data from water rights agency database 104, and any other data from external data sources 108, periodically to update that data maintained in data storage facility 210. The frequency at which the data is updated may be configured by a system administrator, or it may be configured based on user preferences set for all alert rules maintained by the system. For example, the system may update only the water rights data associated with an alert basis at the frequency specified by the user preferences or default settings for the related alert rule. To illustrate, if a user has created an alert rule defining the alert basis as the User's Water Right Inventory previously created by the user, and has set user preferences to scan for water rights events weekly, then the system will obtain data updates from water rights agency database 104 for the water rights included in the User's Water Right Inventory only one time per week.

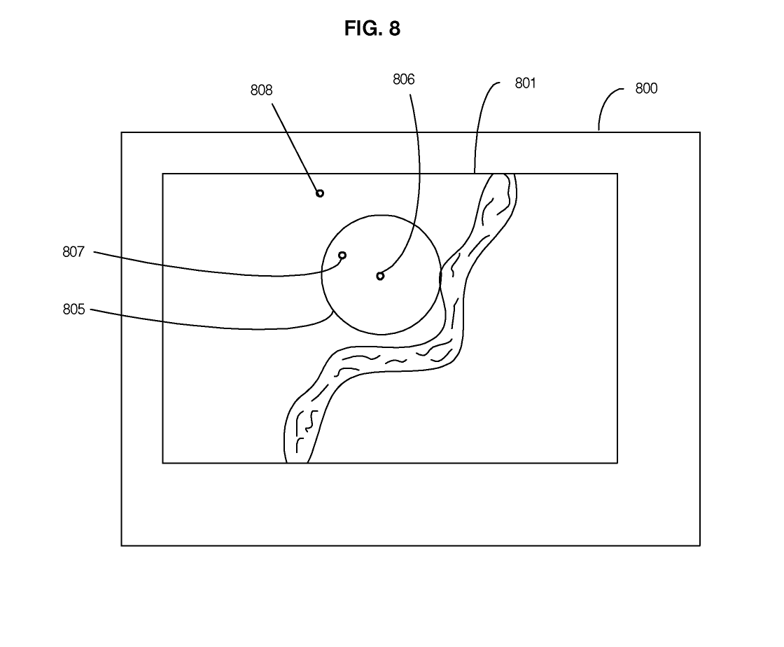

If the alert basis has been defined as a water right, owner, or inventory, relevant water rights events may be any or all of the water rights events associated with the water right, owner, or inventory of the alert basis. If the alert basis has been defined as a geographic alert area, the relevant water rights events may be any or all of the water rights events associated with each water right having at least one geo-referenced water right data element located within the geographic alert area. For example, as shown in user interface 800 depicted in FIG. 8, a user has defined on geo-reference base layer 801 a geographic alert area 805 having a radius of one mile around a groundwater well 806 associated with a first water right. A second water right has a first POD 807 located within the geographic alert area 805. If the owner of the second water right files a change application seeking to add a second POD 808 located outside the geographic alert area 805, the system will provide an alert of the change application because first POD 807 is located within the geographic alert area 805.

Alternatively, relevant water rights events may be only those water rights events having at least one geo-referenced water rights data element located within the geographic alert area. In the example shown in FIG. 8, the system would not provide an alert of the change application seeking to add second POD 808 because second POD 808 is not located within the geographic alert area 805. The criteria for determining relevancy of water rights events may be adjusted and configured by the user by setting user preferences.

The alert may be provided to the user in many different ways. In one exemplary embodiment, the alert may be provided by transmitting a message to the user via an email, SMS, MMS, voice or audio message, fax, or other “push” notification as available, or the like to a device associated with the user. In another exemplary embodiment, the alert may be provided via a website associated with the system, and thus may be available on demand when the user logs in to the website. The system may also maintain a database of all alerts previously given to the user, so the user can access those alerts at a later date.

The system may also be configured to provide the alert to more than one recipient, and the recipients may be any persons that the user designates, including the user, the user's attorney or engineer or other professional, or any other recipient desired by the user.

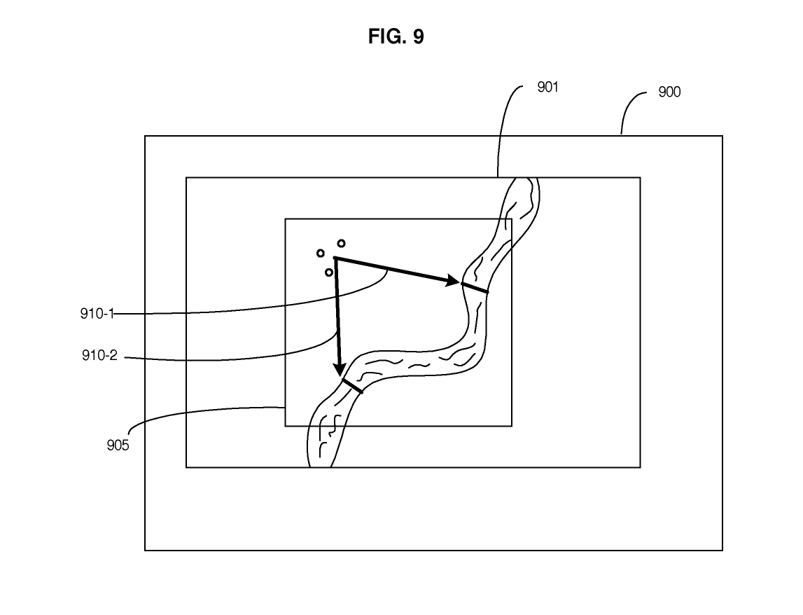

The alert can be in many different forms. In one embodiment, the alert may be a textual notification with information about the water rights event. The alert may also include a hyperlink to the record or data file of the water rights agency database and/or the system database. In another exemplary embodiment, the alert may comprise a report, whether in PDF or other format. The alert may also display graphically the information about the relevant water rights events in any of the forms and formats set forth in co-pending U.S. patent application Ser. No. 13/772,996, which is incorporated herein by reference in its entirety. As shown in exemplary user interface 900 depicted in FIG. 9, this may include showing, on geo-reference base layer 901, change lines 910-1 and 910-2 representing a change application moving PODs into or within the alert area 905. The system may allow the user to define user preferences for how the alerts are provided, including the form and format of the alerts, the recipient(s) of the alerts, and the content included in the alerts.

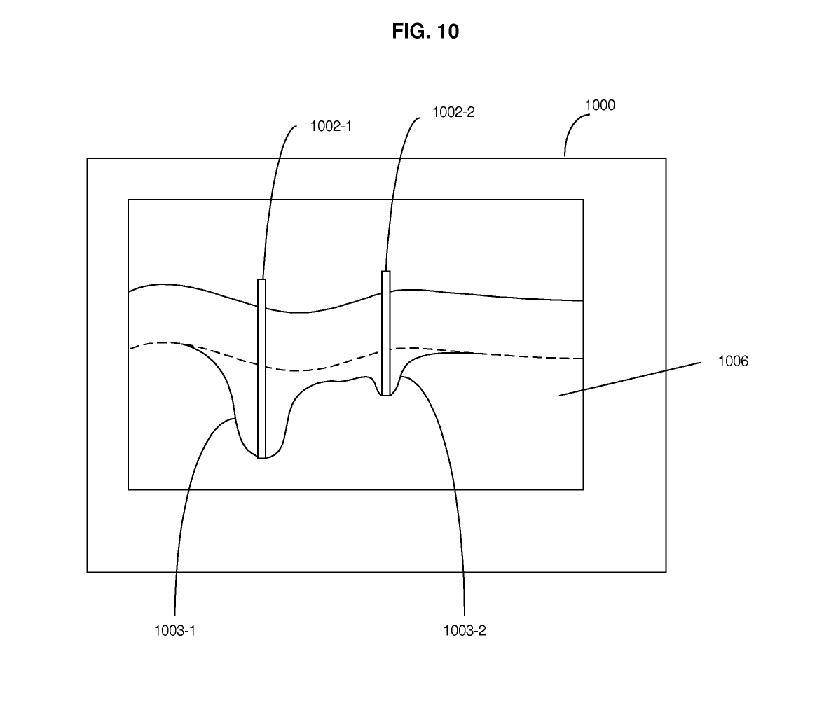

In another exemplary embodiment, as shown in user interface 1000 depicted in FIG. 10, the alert may graphically show, whether in three-dimensional or two-dimensional views, cones of depression 1003-1 and 1003-2 of groundwater wells 1002-1 and 1002-2 included in the geographic alert area and/or the specified aquifer 1006. The system may utilize data about the aquifer characteristics and hydrogeology, as obtained from the water rights agency databases 104 and/or external data sources 108, and use this data to predict cones of depression and the effect of groundwater wells on water in the aquifer. The alerts can be configured to allow a user to predict, or model, the effects of groundwater diversions based on variables input from the user regarding well depth, pump rates, well size, pump capacity, and the like. In another embodiment, the system predicts drawdown in wells based on aquifer data, hydrogeologic characteristics, and/or data contained in well logs within the alert area. In another embodiment, a user may input into the system databases known aquifer data, hydrogeologic characteristics, and/or data contained in well logs for the alert area of interest so that the system can use that data to predict the effects of water rights activities that are the subject of water alerts, such as new PODs.

The alert may also utilize data about water rights associated with the relevant water rights events and water rights associated with the alert basis to provide a comparison or summary of water right data elements and features. For example, the alert may display a comparison of well depths and distances and other well features, whether graphically or textually or numerically. It may also provide statistics and rankings of the wells in the basin, such as a Pareto ranking of best to worst.

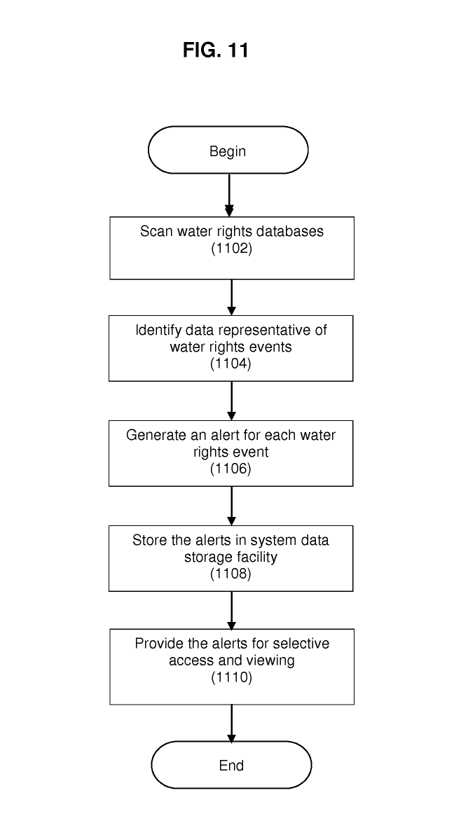

In addition to the user-defined alert rules, as described above, the system may also provide an automatic alert detection without the need for a user definition of the alert basis. FIG. 11 shows one embodiment of a process that implements functions of the water rights monitoring system described above. While FIG. 11 illustrates exemplary steps according to one embodiment, other embodiments may omit, add to, reorder, and/or modify any of the steps shown in FIG. 11. In certain examples, one or more of the steps shown in FIG. 11 may be performed by a water rights monitoring system such as the water rights monitoring system 101 described above.

In this automatic alert detection method, the system scans the water rights databases included in data storage facility 202 (step 1102) and, because all water rights events are relevant, identifies data representative of all water rights events (step 1104). The system may scan the databases and identify data representative of the water rights events in any manner as described herein. If the system identifies data representative of water rights events, the system generates an alert of each water rights event (step 1106) and stores the alerts in the system data storage facility (step 1108). The alerts may include any of the information, and have any format, as described herein. The alerts are then provided for selective access and viewing by one or more users at any time by accessing the system and retrieving one or more alerts from the system databases (step 1110). The user can view the alerts within the system website, or may select to have the alerts provided to the user, in any method as described herein. In one exemplary embodiment, the system settings and preferences for performing the automatic alert detection may be set by a system administrator.

The automatic alert detection method provides many benefits, including allowing professional service providers, such as law firms and engineers, to identify potential clients that may need assistance in taking appropriate actions in response to the water rights events. It also provides a way for users to view alerts on demand without having to create an alert rule or subscribe to regular notices, which may be preferable for a user only wishing to occasionally monitor water rights. It also provides another metric by which water rights data can be filtered and displayed by the methods and systems described in co-pending U.S. patent application Ser. No. 13/772,996.

The system may also be configured for the user to subscribe to the alerts, and to require payment for providing the alerts. This may be done in many different ways, such as providing a monthly service charge, a per-alert charge, or other arrangement. Payment under the subscription may be for a subscription period. The expiration of the subscription period may be shown graphically on the website.

The system may be configured for both individual users as well as professional users, such as engineers and attorneys. In the professional version, the system may allow the professional to maintain a database of clients, and each client can then have its own inventory of water rights and defined water right rules.

The water rights monitoring system and methods described herein provide a unique and powerful tool for providing alerts to users of important events and action dates with regard to water and water rights that otherwise is not available with prior art systems. The teachings of this disclosure are not exhaustive and do not recite every embodiment; indeed, there are many embodiments and features that are within the scope of this disclosure, and as such this disclosure is not intended to be limiting in any way.

What is claimed is:

1. A method comprising:
obtaining, by a water rights monitoring system, water rights data from a water rights agency database;
maintaining, by the water rights monitoring system, a water rights database comprising the water rights data;
receiving, by the water rights monitoring system, a user definition of an alert basis;
scanning, by the water rights monitoring system, the water rights database to identify data representative of one or more relevant water rights events; and
providing, by the water rights monitoring system, one or more alerts of the one or more relevant water rights events,
wherein the one or more relevant water rights events are associated with the alert basis.

2. The method of claim 1, wherein the alert basis includes at least one of a water right, a water right owner, and an inventory.

3. The method of claim 1, further comprising:
receiving, by the water rights monitoring system, one or more user preferences for identifying relevant water rights events,
wherein the scanning of the water rights database and the providing of the one or more alerts are performed in accordance with the user preferences.

4. The method of claim 3, wherein the one or more user preferences define relevant water rights events based on one or more categories or types of water rights events.

5. The method of claim 3, wherein the one or more user preferences define relevant water rights events based on one or more water rights data elements.

6. The method of claim 5, wherein the one or more water rights data elements include at least one of a quantity, a flow rate, a depletion percentage, and a nature of use.

7. The method of claim 3, wherein the one or more user preferences specifies a frequency for at least one of the obtaining of the water rights data from the water rights agency database and the scanning of the water rights database to identify the data representative of the one or more relevant water rights events.

8. The method of claim 1, wherein
the alert basis includes a geographic alert area, and
each of the one or more relevant water rights events are associated with a water right having at least one geo-referenced water rights data element located within the geographic alert area.

9. The method of claim 1, wherein
the alert basis includes a geographic alert area, and
each of the one or more relevant water rights events has at least one geo-referenced water rights data element located within the geographic alert area.

10. The method of claim 1, wherein the receiving of the user definition of the alert basis comprises:
receiving, from the user, a water rights data text search query;
scanning the water rights database to identify data representative of one or more water rights that match the search query;
receiving, from the user, a selection of at least one of the one or more water rights for inclusion in the alert basis;
determining a geographic starting point location based on the user selection; and
defining an alert area around the geographic starting point location.

11. The method of claim 10, wherein the geographic starting point location includes at least one of a point of diversion and a place of use.

12. The method of claim 1, wherein the receiving of the user definition of the alert basis comprises:
receiving, from the user, a direct geographic location search query;
determining a geographic starting point location based on the direct geographic location search query; and
defining an alert area around the geographic starting point location.

13. The method of claim 12, wherein the direct geographic location search query comprises at least one of a user placement of a placemark on a geo-reference base layer, a parcel search, and a location search.

14. The method of claim 1, wherein the receiving of the user definition of the alert basis comprises receiving, from the user, a designation of an alert area,
wherein the alert area includes at least one of a county, a hydrologic basin, a hydrologic sub-basin, a polygon, and an aquifer.

15. The method of claim 14, wherein the receiving of the designation of the alert area comprises receiving, from the user via a user interface displaying a geo-reference base layer, a designation of a starting endpoint on a river, an ending endpoint on the river, and a width of a river polygon.

16. The method of claim 1, wherein the providing of the one or more alerts includes transmitting a message to a device associated with the user.

17. The method of claim 16, wherein the message includes at least one of an email message, a voice message, a text message, and a fax message.

18. The method of claim 16, wherein the providing of the one or more alerts comprises:
storing the one or more alerts in a data storage facility associated with a website, and
providing the one or more alerts for selective access by the user from the website.

19. The method of claim 16, wherein the one or more alerts graphically shows, as a cone of depression, a predicted effect of a water right event on one or more points of diversion of one or more water rights included within the alert basis.

20. A method, comprising:
periodically obtaining, by a water rights monitoring system, water rights data from a water rights agency database;
maintaining, by the water rights monitoring system, a water rights database comprising the water rights data;
periodically scanning, by the water rights monitoring system, the water rights database to identify data representative of one or more water rights events; and
generating, by the water rights monitoring system, an alert for each of the one or more water rights events;
storing, by the water rights monitoring system in a data storage facility associated with the water rights monitoring system, the alert for each of the one or more water rights events; and
providing, by the water rights monitoring system, the alert for each of the one or more water right events for selective access and viewing by a user.

21. A system, comprising:
a water rights database including water rights data obtained from a water rights agency database;
a geographic information system (“GIS”) dataset that correlates to geo-referenced water rights data in the water rights database;
a search module configured to receive a search query from a user device and search the water rights database to identify at least one of a water right, an owner, an inventory, and a geographic alert area for inclusion in an alert basis; and
an alert module configured to
facilitate a user definition of the alert basis,
scan the water rights database to identify relevant water rights events, and
provide an alert of each of the relevant water rights events.

22. The system of claim 21, wherein the alert module is further configured to
receive a user definition of one or more user preferences, and
scan the water rights database to identify relevant water rights events and provide the alert of each of the relevant water rights events in accordance with the one or more user preferences.
